(19) United States
(12) Patent Application Publication
(10) Pub. No.: US 2010/0025284 A1
(43) Pub. Date: Feb. 4, 2010

(54) POLYGONAL DRAWN CONTAINER AND A FORMING METHOD THEREOF

(75) Inventors: Kei Oohori, Kanagawa-Ken (JP); Kazuhiko Tsukada, Kanagawa-Ken (JP); Toshifumi Takamatsu, Kanagawa-Ken (JP)

Correspondence Address: BURR & BROWN, PO BOX 7068, SYRACUSE, NY, 13261-7068, US

(73) Assignees: Nissan Motor Co., Ltd., Yokohama-Shi (JP); Toyo Seikan Kaisha, Ltd., Chiyoda-ku (JP)

(21) Appl. No.: 12/447,063

(22) PCT Filed: Oct. 24, 2007
(86) PCT No.: PCT/JP2007/070741

§ 371 Date: Apr. 30, 2009

(30) Foreign Application Priority Data
Oct. 27, 2006 (JP) 2006-292499

(51) Int. Cl. B65D 1/34; B29C 51/08; B65D 1/00; B65D 1/42

(52) U.S. Cl. 206/557; 264/500; 220/639

(57) ABSTRACT

A rectangular drawn container and a method for forming the same are provided which can prevent warpage of a bottom portion of a container in a simple way. In a rectangular drawn container that is provided with a polygonal bottom panel portion and a body portion of a polygonal tubular shape rising from peripheral edges of the bottom panel portion, a convex bead is formed on the bottom panel portion at a location in the vicinity of at least one bottom side rounded portion among bottom side rounded portions of the body portion, at an inner side of the container so as to extend in parallel to the at least one bottom side rounded portion at a predetermined distance therefrom. The bottom panel portion takes a rectangular shape, and the bead is arranged along a pair of bottom side rounded portions at long sides of the bottom panel portion.

### TECHNICAL FIELD

The present invention relates to a container of a bottomed tubular shape, and in particular, it relates to a polygonal drawn container.

### BACKGROUND ART

As this kind of polygonal drawn container, there can be considered such a construction as illustrated in FIG. 5.

That is, this polygonal drawn container 100 is provided with a bottom panel portion 101 of a rectangular shape, a body portion 102 of a rectangular tubular shape that is formed to rise integrally from an outer edge of this bottom panel portion 101, and a seam flange 103 that is formed to protrude from an opening edge of the body portion 102, wherein an unillustrated lid member can be seamed to the flange.

However, in the case of such a polygonal drawn container, if the depth of the body portion 102 is shallow as compared with the size of the bottom panel portion 101, warpage (twist) of the container might be caused around a diagonal line thereof due to a residual strain, as shown in FIG. 5(B). In case where an arbitrary pattern such as an embossed portion 104, etc., is formed on the bottom panel portion 101, as illustrated, such warpage of the container is liable to occur due to a strain in the bottom panel portion 101. In particular, such a tendency is remarkable with aluminum, titanium, high-tensile steel and so on, which have a large spring back.

With some products, there is a method of curling or hemming an open end portion of a container to increase the rigidity thereof to suppress the warpage of the container by means of the thus increased rigidity, but in the case of seamed containers, a seam flange such as the above-mentioned one 103 should be left, so the warpage of the body portion 102 before being seamed can not be suppressed, thus often resulting in defective seaming.

As set forth in a first patent document, there is an effective method in which a bottom panel portion of a container is formed to protrude inwardly in an offset manner with respect to an outer peripheral portion thereof, so that the rigidity of the periphery of the bottom portion is increased so as to suppress the warping thereof. However, in case where internal parts in the container are fixed things or the like, it is not easy to adopt such a method because of interference, a decrease in a storage space of the container, etc.

The construction of a general rectangular drawn container other than the above is described in a second patent document, etc.

### [First Patent Document]

Japanese patent application laid-open No. H 5-42938

### [Second Patent Document]

Japanese patent application laid-open No. H 7-314068

### DISCLOSURE OF THE INVENTION

### Problems to be Solved by the Invention

The present invention has been made to solve the problems of the prior art as referred to above, and has for its object to provide a rectangular drawn container and a method for forming the same in which warpage of a bottom portion of the container can be prevented in a simple way.

### Means for Solving the Problems

In order to achieve the above object, the invention related to claim 1 is characterized in that a polygonal drawn container comprises a bottom panel portion of a polygonal shape, and a body portion of a polygonal tubular shape rising from peripheral edges of the bottom panel portion, wherein on the bottom panel portion at a location in the vicinity of at least one bottom side corner portion among bottom side corner portions of the body portion, one or plurality of convex beads are formed at an inner side of the container so as to extend in parallel to the at least one bottom side corner portion at a predetermined distance therefrom.

The invention related to claim 2 is characterized in that the bottom panel portion is of a rectangular shape, and the bead is arranged along a pair of bottom side corner portions at long sides of the bottom panel portion.

The invention related to claim 3 is characterized in that emboss processing is applied to a central portion of the bottom panel portion.

A method of forming a rectangular drawn container, related to claim 4, is characterized by comprising a drawing step of forming a polygonal container main body of a bottomed tubular shape having a polygonal bottom panel portion and a polygonal tubular body portion by drawing a plate material, and a bead forming step of forming, after the drawing step, one or plurality of convex beads at an inner side of the container in the vicinity of at least one bottom side portion among container body bottom side portions of a bottom of said container, said one or plurality of convex beads extending in parallel to the at least one container body bottom side portion at a predetermined distance therefrom.

The invention related to claim 5 is characterized by further comprising a trimming step of forming, after the formation of the bead, a seam flange by trimming a projected portion formed at an upper end of the body portion during the drawing step.

### EFFECTS OF THE INVENTION

In the case of a polygonal drawn container, owing to residual stresses remaining in bottom side corner portions located at corner portions of a bottom panel portion and a body portion thereof, the container has a moment acting in a direction to cause the body portion to open outward, but according to the rectangular drawn container of the present invention, by the provision of the bead in the vicinity of the bottom side corner portions of the body portion, there is generated a moment acting in a direction to counteract a moment that acts to cause the body portion to open outward, whereby these moments are canceled out with each other, thus making it possible to prevent the occurrence of warpage of the bottom of the container.

In addition, in the case of the bottom panel portion being of a rectangular shape, the warpage of the bottom panel portion can be canceled in an effective manner by the provision of the bead at the long sides thereof at which a great influence will be produced.

In particular, even in case where emboss processing is applied to the bottom panel portion, a resultant influence is interrupted or separated from the residual moment in the body portion by means of the bead, thus making it possible to prevent the occurrence of warpage.

According to the method of forming a rectangular drawn container of the present invention, the warpage of the container can be prevented by means of the bead forming step, so post-processing can be carried out in a smooth manner.

In addition, even if the trimming processing of the seam flange is carried out after the formation of the bead, no warpage will be generated, thus making it possible to prevent defective seaming.

### BRIEF DESCRIPTION OF THE DRAWINGS

FIG. 1 shows a rectangular drawn container according to one embodiment of the present invention, wherein (A) in this figure is a perspective view with a bottom panel portion thereof being arranged at top, and (B) in this figure is an enlarged cross sectional view of a vicinity of a bead portion.

FIGS. 2(A) through 2(C) are views showing forming steps of the rectangular drawn container in FIG. 1.

FIG. 3 is a view for explaining a warpage prevention function due to the bead, wherein (A) and (B) in this figure are explanatory views of a residual stress state and a deformed state, respectively, in case where no bead is provided, and (C) in this figure is an explanatory view of a residual stress state in case where a bead portion is provided.

FIG. 4 (A) and (B) in FIG. 4 are perspective views showing rectangular drawn containers, respectively, according to other embodiments of the present invention with bottom panel portions thereof being arranged at top.

FIG. 5 shows a rectangular drawn container as a background art of the present invention, wherein (A) in this figure is a perspective view with a bottom panel portion thereof arranged at top, and (B) in this figure is a view showing a warpage generation state.

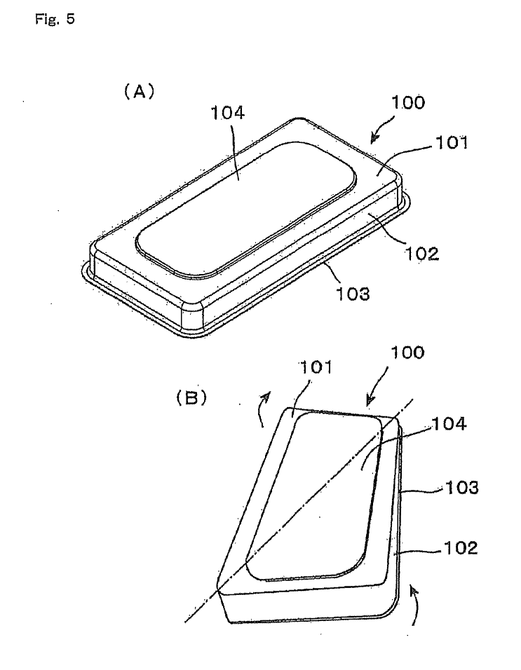

### EXPLANATION OF SYMBOLS

1 a rectangular drawn container
2 a bottom panel portion
3 a body portion
4 bottom side rounded portions (bottom side edges)
5 beads
6 an embossed portion
7 a protruded portion
8 a seam flange

### DESCRIPTION OF THE PREFERRED EMBODIMENTS

Now, preferred embodiments of the present invention will be described below while referring to the accompanying drawings.

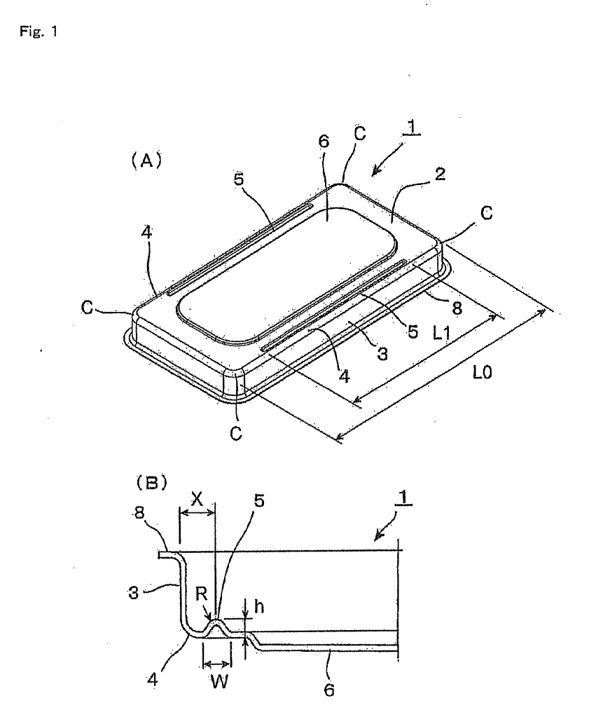

FIG. 1 shows a polygonal or rectangular drawn container according to one embodiment of the present invention.

This polygonal drawn container 1 is made of thin metal, and is provided with a bottom panel portion 2 of a rectangular shape and a body portion 3 of a polygonal tubular shape rising from peripheral edges of the bottom panel portion 2. A variety of metal materials such as aluminum plate, titanium, high tensile steel sheet and so on are available as materials for forming the container.

The body portion 3 has a rectangular cross-sectional shape with round corners C, and the body portion 3 and the bottom panel portion 2 have bottom side corners each of a circular arc shape. In addition, the body portion 3 has an open end portion with a seam flange 8 protruding therefrom over and along the entire periphery thereof.

Assuming that the bottom side edges of the body portion 3 and the bottom panel portion 2 are referred to as bottom side rounded portions 4, in the vicinity of the bottom side rounded portions 4 at a pair of long sides of the bottom panel portion 2, convex beads 5 are formed at the inner side of the container so as to extend in parallel to the bottom side rounded portions 4, respectively, at a predetermined distance therefrom. In addition, an embossed portion 6 protruding outside of the container is formed in a central region of the bottom panel portion 2.

The beads 5 each take a rounded circular arc cross sectional shape, and extend in a straight line along the bottom side rounded portions 4, respectively, with their opposite ends being spaced a predetermined distance from corresponding corner portions C, respectively. In the illustrated example, the beads 5 extend in a continuous manner, but may be each formed in a discontinuous manner so that they each include a plurality of bead segments each having a predetermined length.

The beads 5 each have a width W and a height h which are set to optimal values, respectively, as required, depending upon the quality of material, the thickness, and the longitudinal and transverse dimensions of the bottom panel portion 2 as well as the height or vertical dimension of the body portion 3. When the container was formed by molding by use of an aluminum material having a thickness of 0.5 mm, while forming the beads 5 each having a radius of curvature R of about 1.5 mm, the occurrence of warpage of the container could be suppressed. It was also found that such an effect varied in accordance with a distance X from an outer side surface of the body portion 3 to an adjacent bead 5 (the center of the bead), a distance of up to about 7 mm was effective, and there was no effect when the distance exceeded 10 mm. However, optimal values for the above dimensions, distance and the like are selected in an appropriate manner, as necessary.

In addition, when the length L0 of each of the beads 5 was set to about 50-80% of the longitudinal length L1 of the container, the effect of preventing the warpage of the container was recognized.

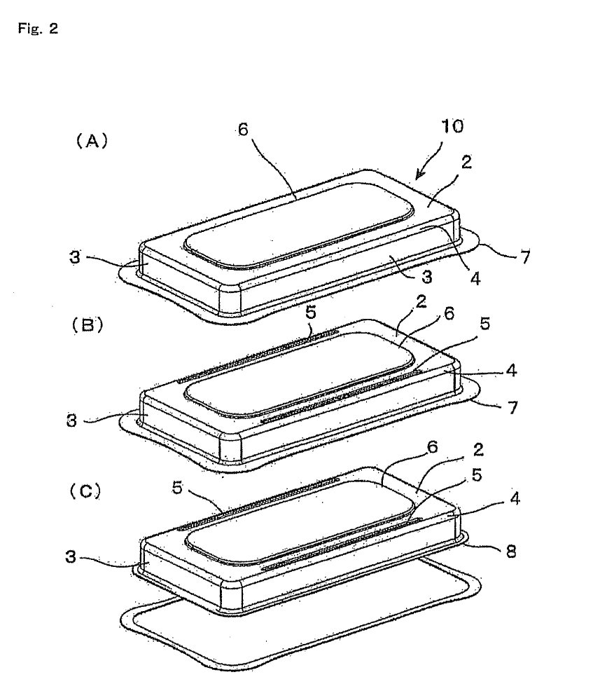

FIG. 2 shows a process of forming the above-mentioned rectangular drawn container.

The forming includes a drawing step of drawing an unillustrated blank to form or mold a container main body (see FIG. 2(A)), a bead forming step of forming or molding beads on a bottom panel portion (see FIG. 2(B)), and a trimming step of trimming a flange (see FIG. 2(C)).

In the drawing step, an unillustrated plate material is drawn to form or mold a polygonal or rectangular container main body 10 of a bottomed tubular shape that is provided with a bottom panel portion 2 and a body portion 3.

In the bead forming step, beads 5 extending in parallel to the bottom side rounded portions 4, respectively, at a predetermined distance therefrom, are formed on the bottom side rounded portions 4 at the long sides of the bottom panel portion 2.

In the trimming step, a protruded portion 7 which is formed to protrude outwardly from the body portion 3 is trimmed to a predetermined width to form a seam flange for seaming a lid member.

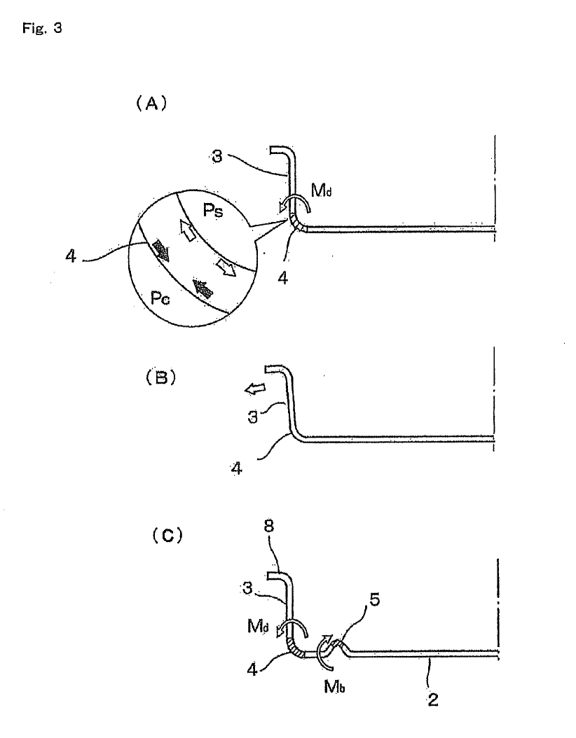

Conventionally, as shown in FIG. 3(A), a tensile stress Ps corresponding to a compressive strain remains at an inner peripheral side of each of the bottom side rounded portions 4 located at the bottom sides of the body portion 3 because the inner peripheral side of each of the bottom side rounded portions 4 is compressed, whereas a compressive stress Pc corresponding to a tensile strain remains at an outer peripheral side of each of the bottom side rounded portions 4 because the outer peripheral side of each of the bottom side rounded portions 4 is subjected to a tensile force. As a result, it is considered that due to these residual stresses, a moment Md acts on the body portion 3 so as to cause it to open outward, and hence the body portion 3, being of a polygonal shape, can not keep balance in accordance with the increasing moment Md because of its shape, so the bottom panel portion 2 is caused to warp around its diagonal line.

According to the present invention, it is considered that a moment Mb acts on the beads 5 in a direction to counteract the moment Md that causes the body portion 3 to open outward, as shown in FIG. 3(C), thus making it possible to suppress the warpage of the bottom panel portion 2.

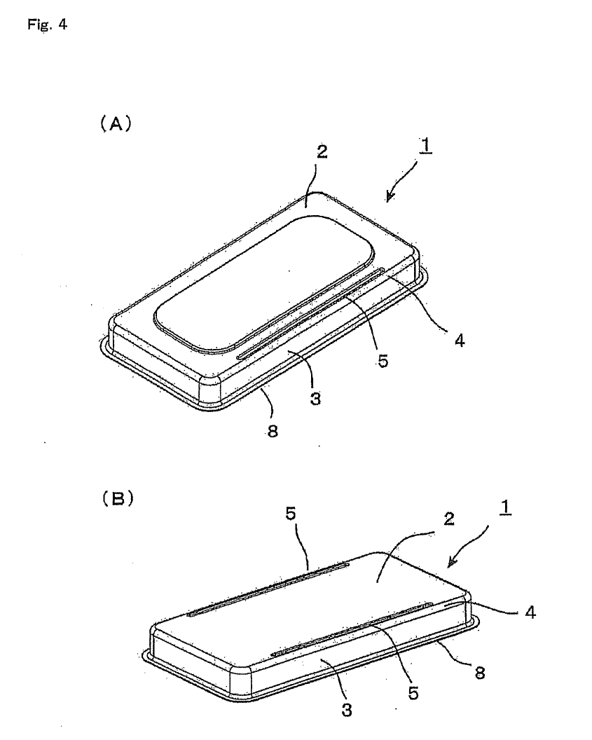

In the above-mentioned embodiment, the beads 5 are formed in two places along the bottom side rounded portions 4 located at both the right and left sides of the bottom panel portion 2, but a bead 5 may be only formed along one of the long sides of the bottom panel portion 2, as shown in FIG. 4(A), or beads 5 may be formed on not only the long sides but also on the short sides thereof.

In addition, the present invention can also be applied to a container that has no convex or concave pattern such as an embossed portion on the bottom panel portion 2, as shown in FIG. 4(B).

Further, although the shape of the body portion 3 has been described such that the body portion 3 is formed to rise perpendicularly from the bottom panel portion 2, the present invention is not limited to this, but can be applied to body portions of a variety of shapes such as for example a tapered tubular shape expanding toward an open end, a stepped shape or the like.

In addition, although in the above-mentioned embodiment, the description has been given by taking a rectangular drawn container as a polygonal drawn container, the shape of the drawn container is not limited to a rectangle but may be a square. Although in general, a polygonal can indicates a form of quadrate or rectangular can, but the rectangular shape of a rectangular drawn container of the present invention is not limited to a rectangle or quadrangle, but may be applicable to a container of a polygonal shape such as triangle, pentagon, hexagon, etc.

1. A polygonal drawn container comprising a bottom panel portion of a polygonal shape, and a body portion of a polygonal tubular shape rising from peripheral edges of said bottom panel portion,
wherein on said bottom panel portion at a location in the vicinity of at least one bottom side corner portion among bottom side corner portions of said body portion, a convex bead is formed one or plurality of convex beads are formed at an inner side of said container so as to extend in parallel to said at least one bottom side corner portion at a predetermined distance therefrom.

2. The rectangular drawn container as set forth in claim 1, wherein said bottom panel portion takes a rectangular shape, and said bead is arranged along a pair of bottom side corner portions at long sides of said bottom panel portion.

3. The rectangular drawn container as set forth in claim 1 wherein emboss processing is applied to a central portion of said bottom panel portion.

4. A method of forming a rectangular drawn container, comprising a drawing step of forming a polygonal container main body of a bottomed tubular shape having a polygonal bottom panel portion and a polygonal tubular body portion by drawing a plate material, and a bead forming step of forming, after said drawing step, a convex bead one or plurality of convex beads at an inner side of said container in the vicinity of at least one bottom side portion among container body bottom side portions of a bottom of said container, said one or plurality of convex beads extending in parallel to said at least one container body bottom side portion at a predetermined distance therefrom.

5. The method of forming a polygonal drawn container as set forth in claim 4, further comprising a trimming step of trimming, after said bead forming step, a protruded portion, which has been formed on an upper end of said body portion during said drawing step, to form a seam flange.

6. The rectangular drawn container as set forth in claim 2, wherein emboss processing is applied to a central portion of said bottom panel portion.
